(19) United States
(12) Patent Application Publication
(10) Pub. No.: US 2011/0197129 A1
(43) Pub. Date: Aug. 11, 2011

(54) MEDIA FILE ACCESS CONTROL METHOD FOR DIGITAL MEDIA PLAYER, AND METHOD AND DEVICE FOR ADDING MY FAVORITES FOLDER

(75) Inventors: Hung-Yang HSU, New Taipei City (TW); Pei-Ling Lai, New Taipei City (TW); Yang-Peng Chen, New Taipei City (TW); Yung-An Fang, New Taipei City (TW); Hui-Yeen Chen, New Taipei City (TW); Yu-Chi Chang, New Taipei City (TW); Li-Hsuan Chen, New Taipei City (TW)

(73) Assignee: Wistron Corporation, New Taipei City (TW)

(21) Appl. No.: 13/021,385

(22) Filed: Feb. 4, 2011

(30) Foreign Application Priority Data
Feb. 6, 2010 (TW) 099103638

(51) Int. Cl. G06F 3/01

(52) U.S. Cl. 715/716

(57) ABSTRACT

A media file access control method for a digital media player includes a) receiving a mode selection instruction; b) determining whether the mode selection instruction corresponds to a lite mode or a computer file mode; and c) if the mode selection instruction corresponds to the lite mode, performing steps of loading a plurality of multimedia files according to content of a pre-established favorites list recording respective names and storage locations of the multimedia files, and displaying thumbnails of the multimedia files in a first region of a screen of a display element. The thumbnails of the multimedia files are capable of being selected such that the multimedia files can be played directly and instantly.

### CROSS-REFERENCE TO RELATED APPLICATION

This application claims priority of Taiwanese Application No. 099103638, filed on Feb. 6, 2010.

### BACKGROUND OF THE INVENTION

1. Field of the Invention

The present invention relates to a control method and a device for a digital media player, and more particularly, to a media file access control method for a digital media player that is capable of simultaneously displaying a favorites list and instantly playing a specified image file in the favorites list, and to a method and device for adding a my favorites folder.

2. Description of the Related Art

A digital media player is a device, which, after being connected to a television or a display screen, is used to play or display a digital image, photograph, or music file. Although a typical personal computer can also play and display the aforesaid multimedia files for a user, the viewing or listening experience will be unenjoyable and inconvenient due to the limited size of the personal computer display screen, particularly when an entire family wants to enjoy the files played or displayed. Furthermore, with photograph resolutions becoming higher and higher, when displaying images with an extremely high resolution, the computer hardware must be of a certain high level. However, a typical, commercially available digital media player is sufficient to display high-resolution images, and its cost is much lower than a personal computer.

When a user wants to display a photograph file, assuming the photograph file is stored in an external storage device or a network drive, its storage location needs to be found first. The typical interface used for file management in a commercial digital media player is that involving a directory view or a folder view. Therefore, it is necessary for the user to determine in which directory or folder a file is stored, after which the file can be played or displayed according to its storage path.

However, for very young and some elderly users, or users not familiar with computer operation, the method of displaying and playing files in the conventional multimedia player may be not easy. Therefore, it is necessary to resolve this issue so that any user can use the multimedia player easily, regardless of how well he or she is able to operate a computer.

### SUMMARY OF THE INVENTION

Therefore, the object of the present invention is to provide a media file access control method for a digital media player that can simultaneously display a favorites list and instantly play a specified image file in the favorites list, and a method and device for adding a my favorites folder.

According to a first aspect of this invention, the media file access control method for a digital media player of this invention comprises:

a) receiving a mode selection instruction;

b) determining whether the mode selection instruction corresponds to a lite mode or a computer file mode; and

c) if the mode selection instruction corresponds to the lite mode, performing steps of loading a plurality of multimedia files according to content of a pre-established favorites list recording respective names and storage locations of the multimedia files, and displaying thumbnails of the multimedia files in a first region of a screen of a display element, the thumbnails of the multimedia files being capable of being selected such that the multimedia files can be played directly and instantly.

According to a second aspect of this invention, the digital media player of this invention cooperates with a data source to acquire a plurality of multimedia files for presentation on a display element. The digital media player comprises:

a remote control receiver for receiving a mode selection instruction;

a storage unit for storing a pre-established favorites list, content of the favorites list recording respective names and storage locations of the multimedia files; and

a program control module that acquires the mode selection instruction and determines whether the mode selection instruction corresponds to a lite mode or a computer file mode, and if the mode selection instruction corresponds to the lite mode, loads the multimedia files according to content of the pre-established favorites list recording respective names and storage locations from the storage unit, and that displays thumbnails of the multimedia files in a first region of a screen of the display element, the thumbnails of the multimedia files being capable of being selected such that the multimedia files can be played directly and instantly.

According to a third aspect of this invention, the method of adding a my favorites folder for a digital media player comprises:

a) determining whether to establish a new my favorites list folder;

b) waiting for input of a name for the my favorites list folder;

c) providing types of multimedia files for selection; and

d) determining whether establishing of the new my favorites list folder has been successfully completed.

According to a fourth aspect, the digital media player of this invention cooperates with a data source so as to obtain one or more multimedia files for play on a display element. The digital media player comprises:

a remote control receiver for receiving a directional instruction;

a storage unit for storing a favorites list, the favorites list including file paths of the multimedia files; and

a program control module that executes a process of a lite mode and includes
a directory processing unit that loads the multimedia files according to file paths in the favorites list, that generates a thumbnail list for previewing thumbnails of the multimedia files, and that selects a different multimedia file from the thumbnail list according to the received directional instruction,
a play processing unit for playing the multimedia file selected by the directional instruction and generating an image, and
a display control unit that arranges the thumbnail list in a first region of a screen and the image in a second region of the screen, and integrates the thumbnail list and the image into a display signal; and

a video interface which converts the display signal into an output signal that is suitable for display on the display element, and which outputs the output signal to the display element.

### BRIEF DESCRIPTION OF THE DRAWINGS

Other features and advantages of the present invention will become apparent in the following detailed description of the embodiment with reference to the accompanying drawings, of which:

FIG. 1 is a schematic circuit block diagram of the embodiment of a digital media player of the present invention;

FIG. 2 is a schematic view to illustrate a remote controller of the embodiment;

FIG. 3 is a schematic view to illustrate a program control module that executes a media file access control method for a digital media player according to the present invention;

FIG. 4 is a schematic view to illustrate a screen shown on a display element in a select and instant play mode;

FIG. 5 is a schematic view to illustrate a screen of a directory list shown on the display element;

FIG. 6 is a schematic view to illustrate a screen of a folder list shown on the display element;

FIG. 7 is a schematic view to illustrate an operating procedure for adding a multimedia file to a favorites list;

FIG. 8 is a schematic view to illustrate a favorites list and an image list of “my favorites”;

FIG. 9 is a schematic view to illustrate an operating procedure for assigning a favorites list in “my favorites” to be operated in the select and instant play mode;

FIG. 10 is a flow chart to illustrate a processing procedure in a switching mode of a digital media player of the present invention;

FIG. 11 is a schematic view to illustrate how a favorites list may be used after the favorites list is assigned to be operated in the select and instant play mode;

FIG. 12 is a flow chart to illustrate a processing procedure in the select and instant play mode of the digital media player of the present invention;

FIG. 13 is a flow chart to illustrate a method of adding a my favorites folder; and

FIG. 14 is a flow chart to illustrate a method of adding a new file to “my favorites” of the digital media player of the present invention.

### DETAILED DESCRIPTION OF THE PREFERRED EMBODIMENT

### I System Structure

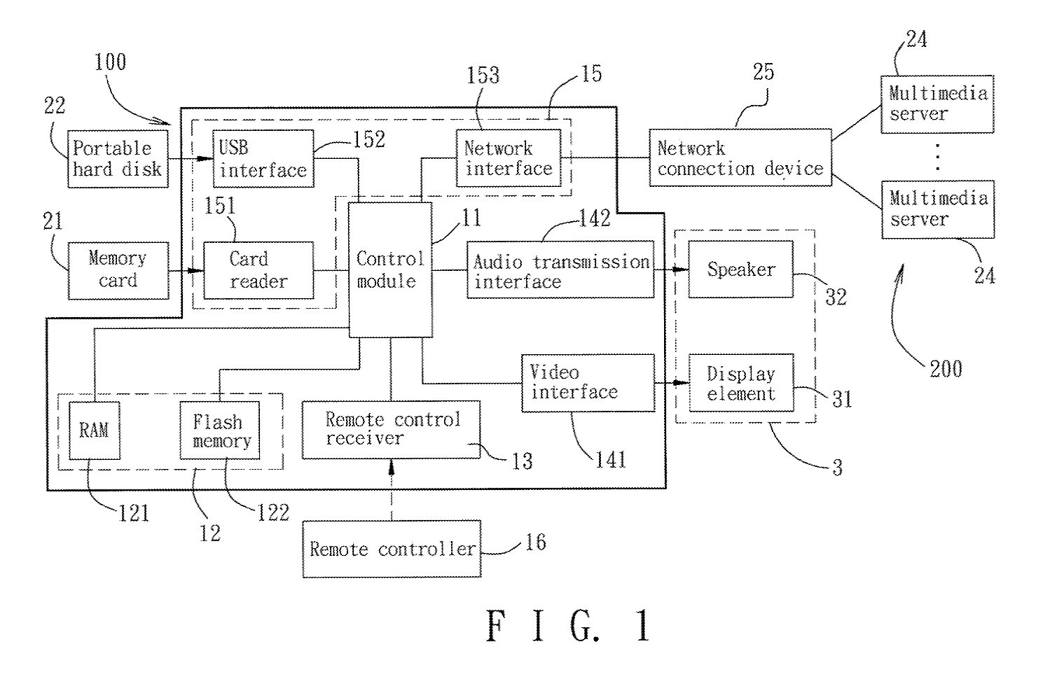

Referring to FIG. 1, an embodiment of a digital media player 100 according to the present invention acquires various types of multimedia files from different data sources 200. The data sources 200 may include (but are not limited to including) a memory card 21 or a portable hard disk 22 connected directly to the digital media player 100, or a plurality of multimedia servers 24 which are connected to the multimedia player 100 via a network connection device 25, such as a router. The multimedia files include any or all of video files, photo files, and music files. In addition, the digital media player 100 is connected to a television 3, and in cooperation with a display element 31 of the television 3, such as a high-resolution display thereof, plays images of the multimedia files, and in further cooperation with a speaker 32 of the television 3, such as a built-in speaker thereof, plays sound of the multimedia files.

The digital media player 100 includes a control module 11, a storage unit 12, a remote control receiver 13, a video interface 141, an audio transmission interface 142, a connection interface 15, and a remote controller 16.

The storage unit 12 includes a RAM (random access memory) 121 and a flash memory 122. The remote control receiver 13 is an infrared receiver that receives control signals from the remote controller 16. The video interface 141 is connected to the display element 31, and outputs an output signal to the display element 31. The output signal is converted from a display signal by the video interface 141 into a signal that suits the display element 31 for display thereon. The audio interface 142 is connected to the speaker 32 for playing sound. The connection interface 15 includes a card reader 151, a USB (Universal Serial Bus) interface 152, and a network interface 153 that are connected to the memory card 21, the portable hard disk 22, and the network connection device 25, respectively. As the aforesaid components are implemented using existing hardware technology, an explanation of the operating principles thereof is omitted herein.

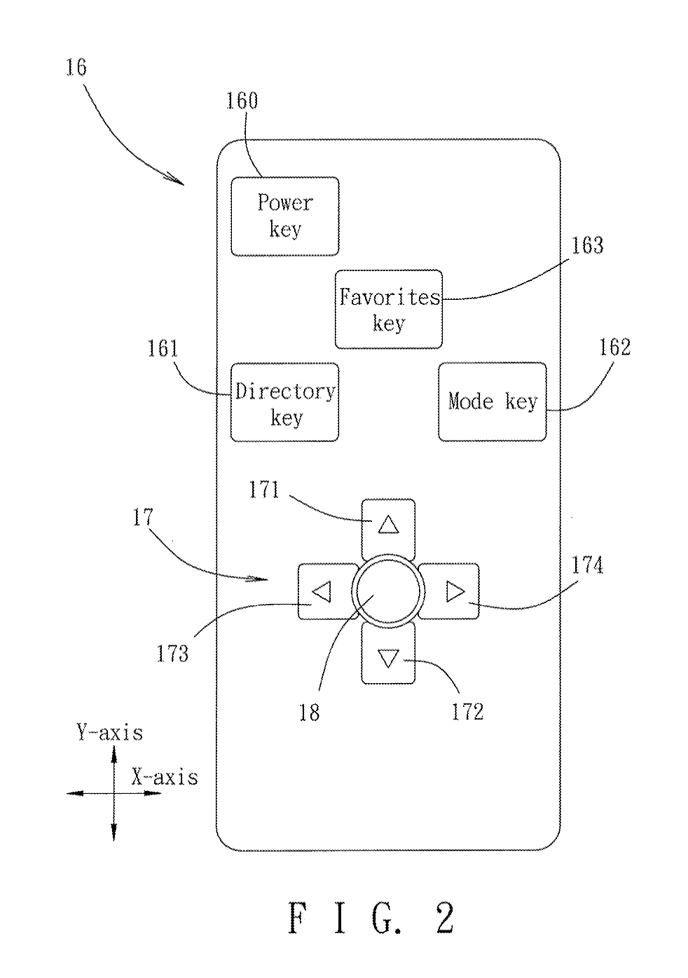

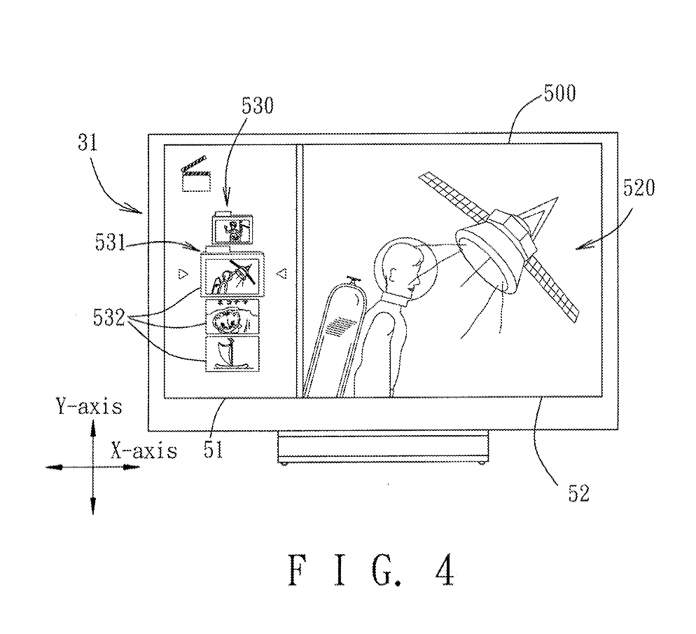

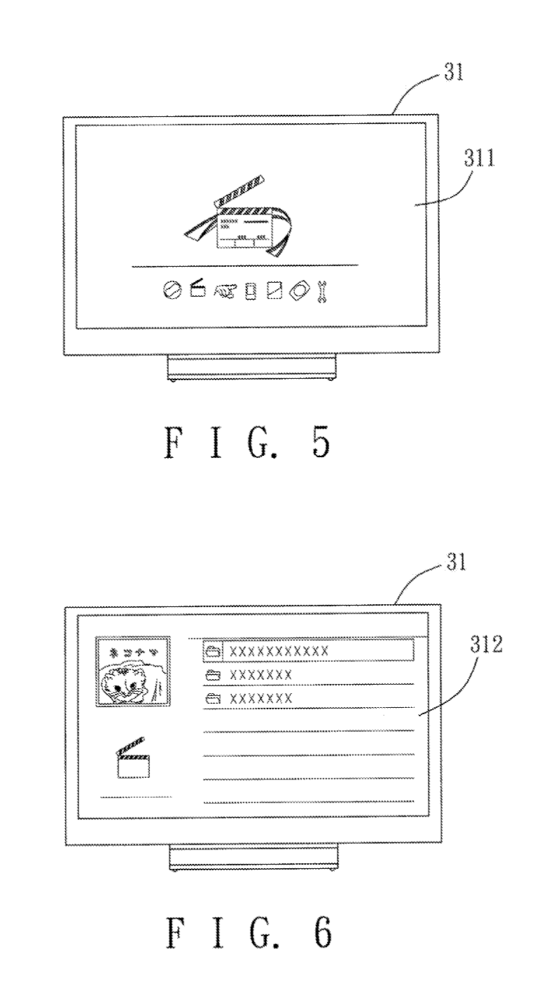

Referring additionally to FIG. 2, the remote controller 16 includes a power key 160, a directory key 161, a mode key (lite key) 162, a favorites key 163, a direction key set 17, and a confirmation key 18. The direction key set 17 includes an up arrow key 171, a down arrow key 172, a left arrow key 173, and a right arrow key 174. When the power key 160 of the remote controller 16 is depressed, a power source of the digital media player 100 is turned on. When the mode key 162 depressed, a mode selection instruction is generated, which is used to switch between screens of a computer file mode and a lite mode of the present invention (see FIG. 4). When the directory key 161 is depressed, a screen of a general directory menu is generated, as shown in FIG. 5.

Referring to FIGS. 1, 2, and 4, a media file access control method for the digital media player 100 of the present invention is described below. After receiving a mode selection instruction, the digital media player 100 determines whether the mode selection instruction corresponds to the lite mode or the computer file mode. If the mode selection instruction corresponds to the lite mode, then multimedia files are loaded according to file content of a pre-established favorites list, as shown in Table 1. Thumbnails 532 of the multimedia files are then displayed in a first region 51 of a screen 500 of a display element 31. These multimedia files can be played instantly by selecting the respective thumbnails 532, and hence, it is not necessary to wait for another media player program to be loaded.

TABLE 1

| Name of multimedia file | Storage location |
|---|---|
| K.jpg | C:/data/photos/K.jpg |
| a.avi | C:/mnt/ubsl/meda/a.avi |
| AMAY.mp3 | C:/data/music/AMAY.mp3 |

Preferably, when the thumbnail 532 corresponding to, for instance, a video multimedia file (for example, a.avi) or a photo multimedia file (for example, K.jpg), is selected, the content of the selected multimedia file is displayed in a second region 52 of the screen 500. When the thumbnail 532 corresponding to a music multimedia file (for example, AMAY.mp3) is selected, its tag information, such as artist name, album title, composer, genre, lyrics, time and/or cover, is displayed in the second region 52 of the screen 500.

Furthermore, names of the multimedia files can be selected by utilizing an instructional scrolling mechanism. With the instructional scrolling mechanism, when a first directional instruction from a first axial direction key set (including the up arrow key 171 and the down arrow key 172) is received, a multimedia file in the same file group may be chosen, and when a second directional instruction from a second axial direction key set (including the left arrow key 173 and the right arrow key 174) is received, a different file group may be chosen.

Referring again to FIG. 1, the control module 11 is a device for controlling the overall operation of the multimedia player 100. Various program control modules and data necessary for processing by the control module 11 are stored in the flash memory 122, and temporary data is stored in the RAM 121.

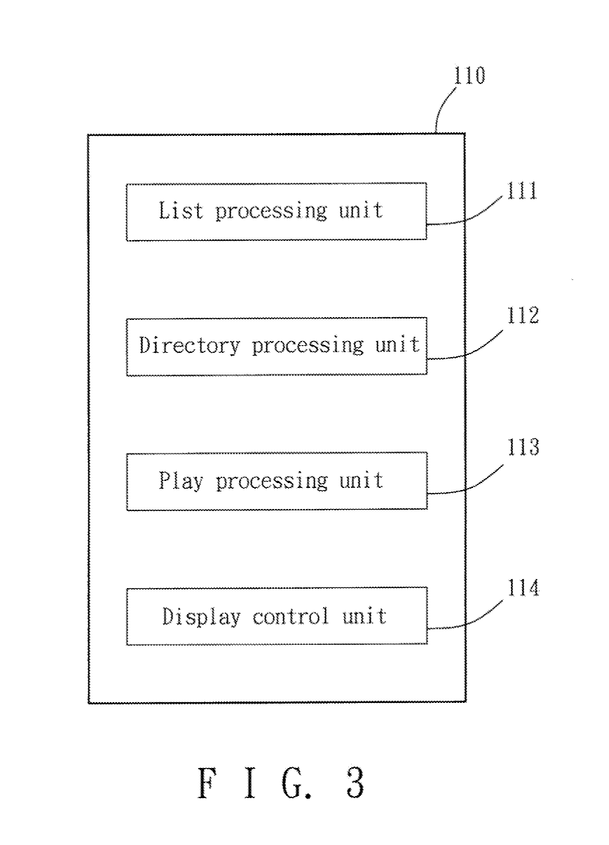

Referring to FIG. 3, a program control module, 110 for carrying out the media file access control method for a digital media player according to the present invention is installed in the control module 11 of FIG. 1. The program control module 110 may be used to implement relevant operations in the lite mode, and includes a list processing unit 111, a directory processing unit 112, a play processing unit 113, and a display control unit 114.

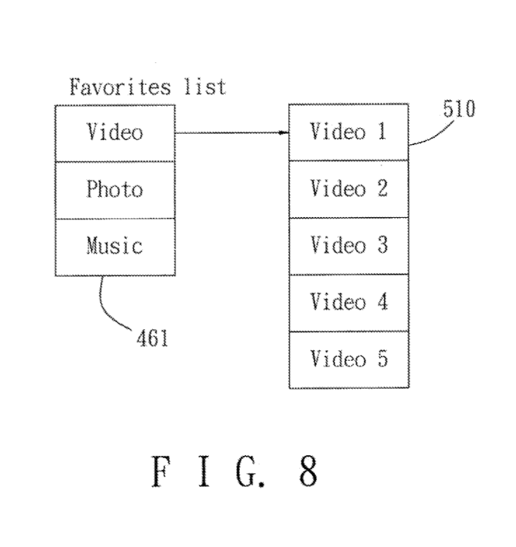

Referring to FIGS. 1 to 4, the list processing unit 111 is used to establish a favorites list and store the favorites list in the flash memory 122. The favorites list includes file paths of multimedia files, and relevant settings are illustrated in FIGS. 7 and 8. In the lite mode, the directory processing unit 112 loads the multimedia files according to file paths of the favorites list pre-established by the list processing unit 111 (for instance, file paths of multimedia files stored in the server 24 or the portable hard disk 22), and generates a thumbnail list 530 for previewing thumbnails 532 of multimedia files. Subsequently, the directory processing unit 112 chooses a multimedia file from the thumbnail list 530 according to the received directional instructions from the remote controller 16 (for example, by manipulation of the up arrow key 171 and the down arrow key 172), and the thumbnails 532 may be previewed by scrolling up and down. The thumbnail list 530 includes a predetermined window 531, and the thumbnail 532 within the predetermined window 531 represents a chosen multimedia file.

The play processing unit 113 plays a multimedia file selected by a directional instruction, and generates an image 520. The display control unit 114 arranges the thumbnail list 530 in the first region 51 of the screen 500 and the image 520 in the second region 52 of the screen 500, and integrates the thumbnail list 530 and the image 520 into a display signal for display on the display element 31.

The direction key set 17 of the remote controller 16 is used to select the multimedia file. Directional keys (i.e., the up arrow key 171 and the down arrow key 172) for a first axis (e.g., the Y-axis) are used to select different multimedia files in the same file group. The different types of file groups include those of the video file type, photo file type, and music file type. For instance, in a file group of the video file type, the source of the thumbnail list in the first region 51 is video files. On the other hand, directional keys (i.e., the left arrow key 173 and the right arrow key 174) for a second axis (e.g., the X-axis) opposite to the first axis are used to select different file groups, that is, the file group of the first region 51 can be changed among thumbnail lists for video files, photo files, and music files.

Therefore, in the lite mode, the up arrow key 171 and the down arrow key 172 of the remote controller 16 may be used to choose a particular video file, after which the video file is automatically played for viewing and listening enjoyment. Moreover, the left arrow key 173 and the right arrow key 174 of the remote controller 16 may be used to choose a particular multimedia type. For instance, the music type can be changed to the photo type, after which a particular music or photo file may be selected and played automatically using the up arrow key 171 and the down arrow key 172.

### II Operating Procedure

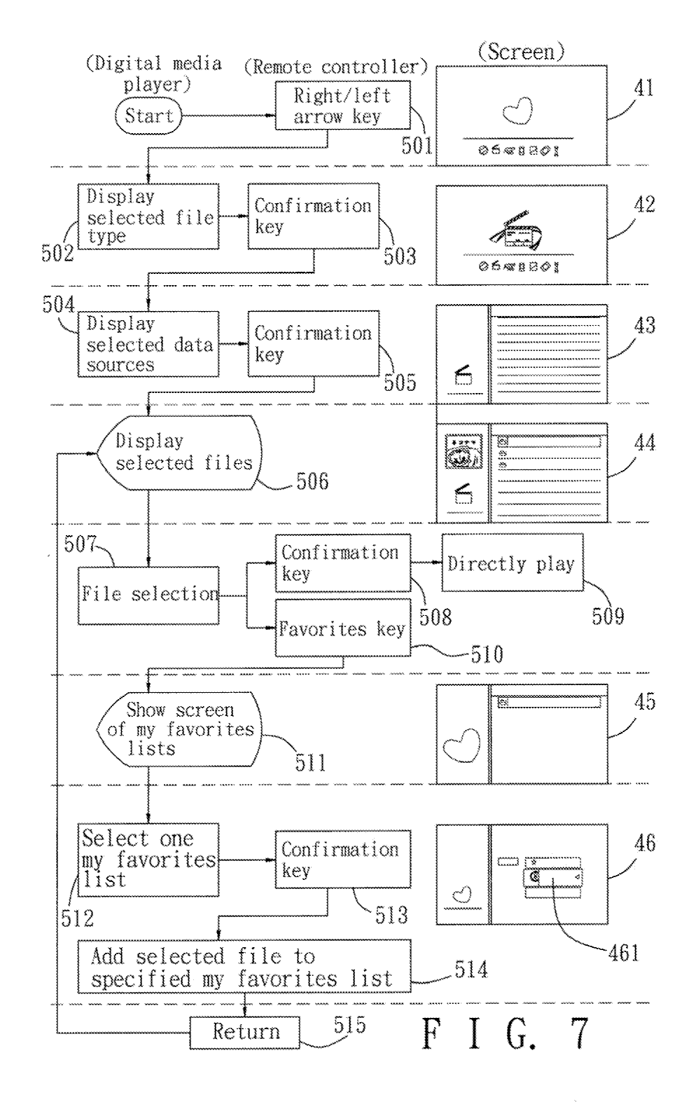

Referring to FIGS. 5 and 6, the display element 31 shows a screen 311 displaying a directory list on a main page. The directory list includes icons of different multimedia types. The left arrow key 173 and the right arrow key 174 of the remote controller 16 may be used to choose a particular multimedia type. For example, if a multimedia type of movies is chosen, a screen 312 of a folder list is generated. After a user selects a file folder, a multimedia file is found in accordance with a multimedia file storage path, and is then played so as to allow watching of the multimedia file.

FIGS. 7 and 8 illustrate the process of adding a multimedia file to a favorites list 461.

Referring to FIGS. 1 and 2, after the multimedia player 100 is started, a directory screen 41 is shown. The directory screen 41 includes a plurality of icon options at a lower portion thereof. The default heart icon represents “my favorites.” Subsequently, the right arrow key 173 or left arrow key 174 is pressed in step 501 so as to display the selected file type in step 502. For instance, if the right arrow key 174 is pressed, then a screen 42 of movie icon options is shown. Next, the confirmation key 18 is pressed in step 503, and a screen 43 of a data source list is shown in step 504 to thereby display the selected data sources. After the confirmation key 18 is pressed in step 505, a screen 44 of a file list is shown so as to display selected files in step 506. In step 507, there are two ways for selecting a file. The confirmation key 18 may be pressed to select a file in step 508, after which the file is played or displayed directly in step 509. Alternatively, the favorites key 163 may be pressed so as to add the file to the favorites list 461 in step 510.

Subsequently and assuming the option of performing step 510 was taken, in step 511, a screen 45 of “my favorites” lists is shown. One of the “my favorites” lists is selected in step 512 and the confirmation key 18 is pressed in step 513. As a result, the selected file is added to the specified “my favorites” list in step 514, i.e., the favorites list 461 in this example. Next, return to the original screen 44 of the file list is performed in step 515.

Referring to FIG. 8, the favorites list 461 of “my favorites” automatically classifies selected files into a video type, a photo type, and a music type, depending on file type. A selected option (for example, the video type) is highlighted. After confirmation, a video list 510 of the selected option will be shown, and a selected video file in the video list 510 will be highlighted.

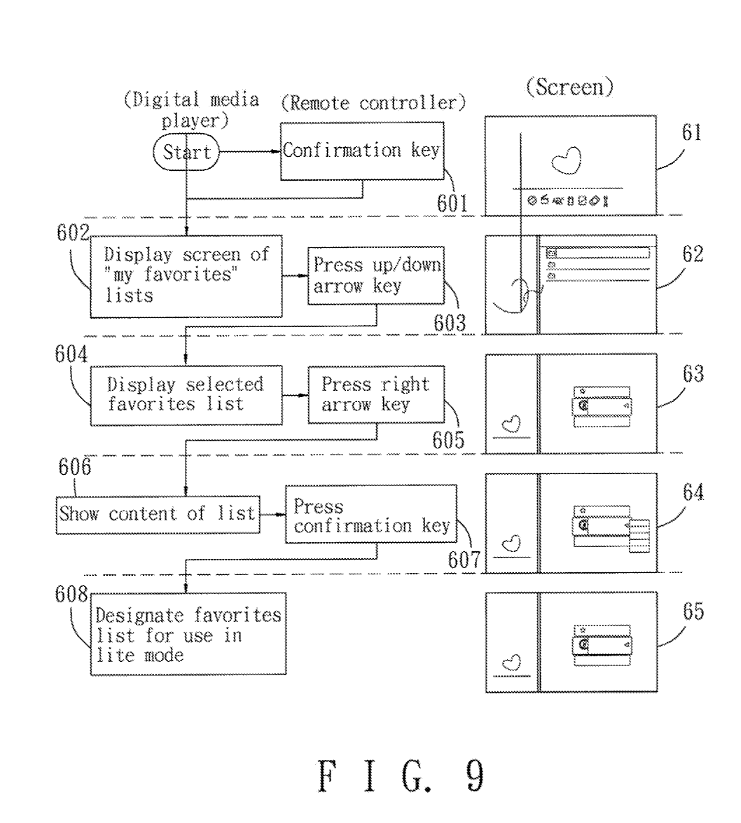

After generating a plurality of favorites lists 461 in “my favorites,” any one of the favorites lists 461 may be assigned to be used in the lite mode. The operating flow of this process is illustrated in FIG. 9.

Referring to FIGS. 1, 2, and 9, when the digital media player 100 displays a screen 61 of “heart” icon option of “my favorites,” the confirmation key 18 is pressed in step 601 to display a screen 62 of “my favorites” lists in step 602. Next, the up arrow key 171 and the down arrow key 172 are pressed in step 603 to display a selected favorites list in step 604, for example, the second favorites list in the “my favorites” lists, as shown in a screen 63. Next, the right arrow key 174 is pressed in step 605. Subsequently, the content of the list is shown in step 606, for example, the content of the second favorites list, as shown in a screen 64. Subsequently, the confirmation key 18 is pressed in step 607. Finally, the favorites list to be used in the lite mode is designated in step 608, as shown in a screen 65.

After the favorites list in “my favorites” is designated in the lite mode, files in the favorites list in “my favorites” may be played directly. The operating flow of this process is described below in detail.

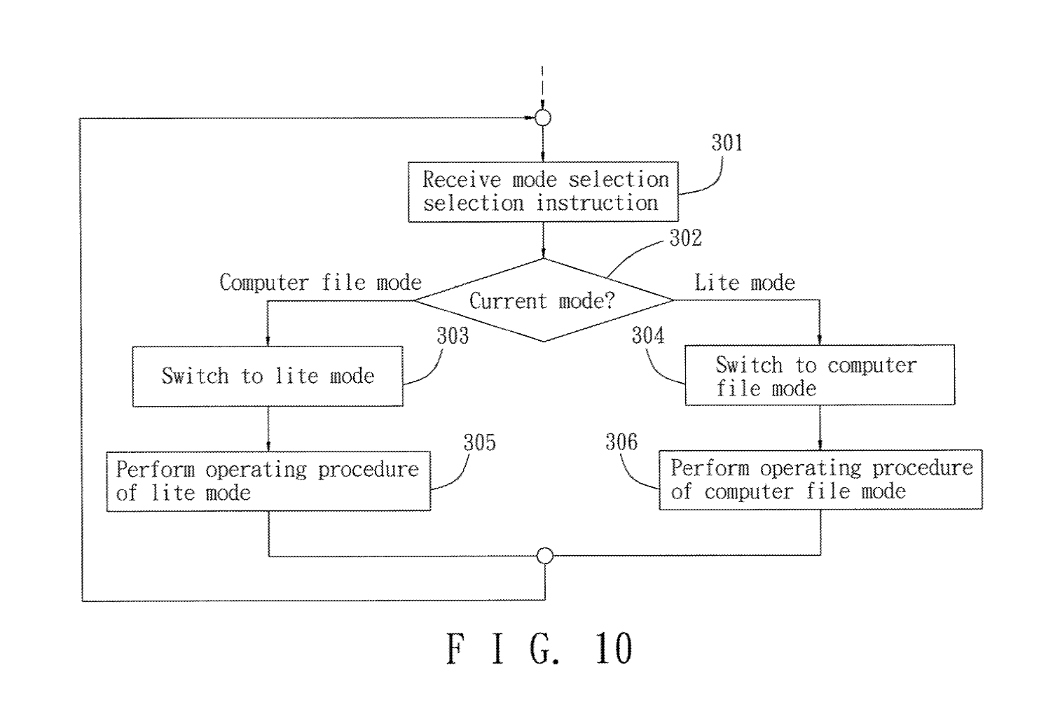

Referring to FIGS. 1, 2, and 10, an operating procedure of a switching mode of the digital media player 100 will now be described. First, the digital media player 100 receives a mode selection instruction in step 301. Next, in step 302, the digital media player 100 determines what the current mode is. If the current mode is a computer file mode, then switching is performed to the lite mode in step 303. Subsequently, an operating procedure of the lite mode is performed in step 305. On the other hand, if the current mode is the lite mode, then switching is performed to the computer file mode in step 304, after which an operating procedure of the computer file mode is performed in step 306.

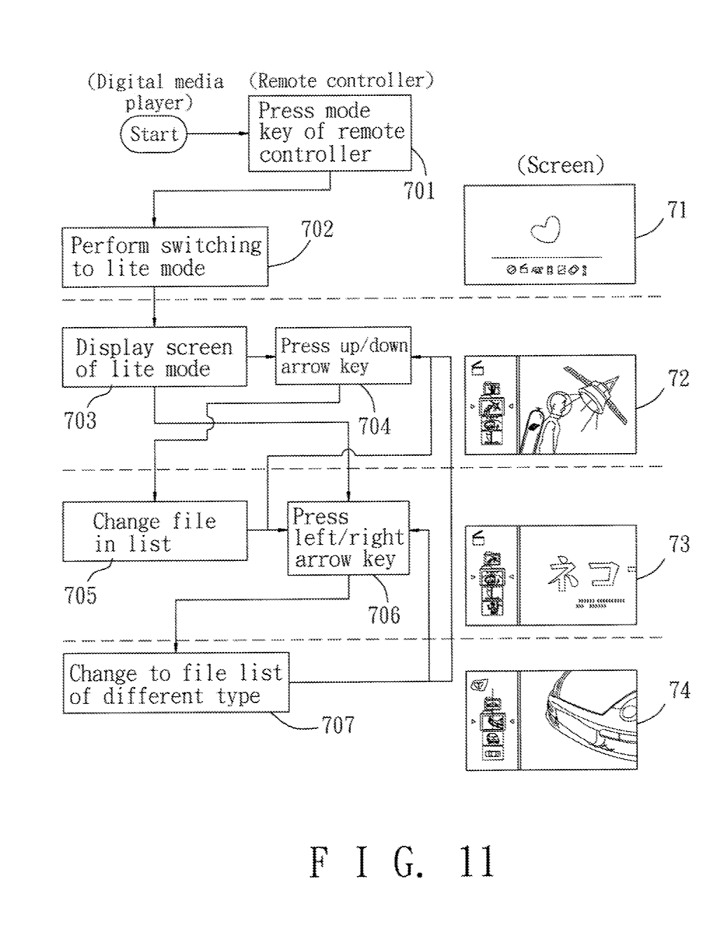

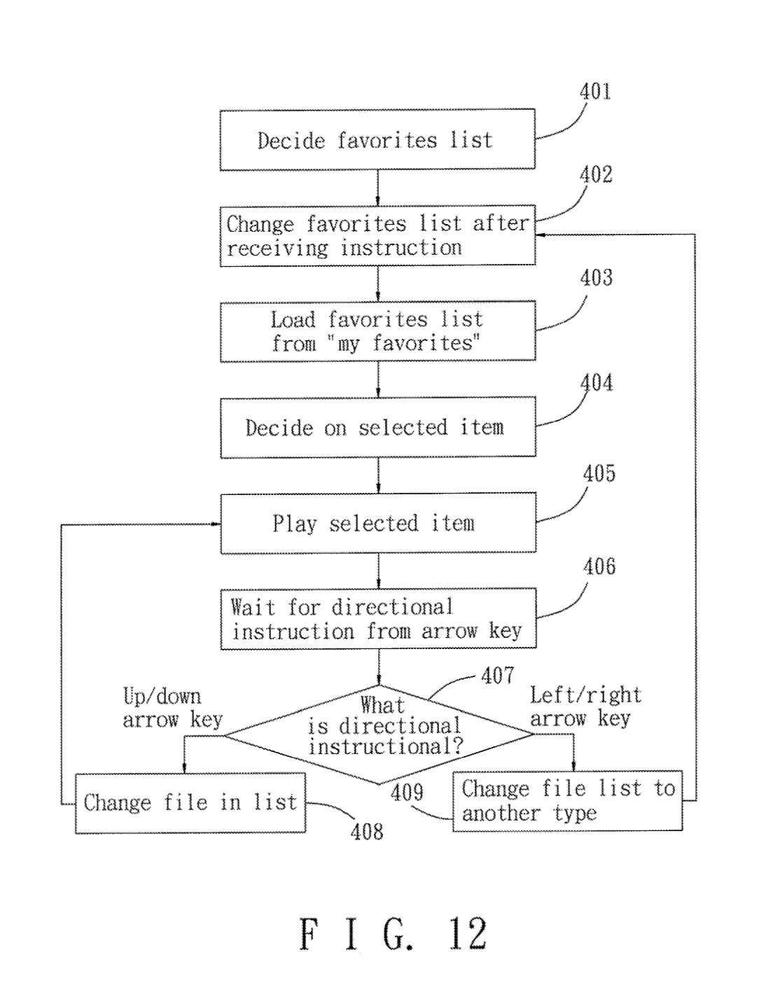

FIG. 11 illustrates a procedure of the lite mode. After the digital media player 100 is started, a screen 71 of the computer file mode is displayed. The mode key 162 of the remote controller 16 is pressed in step 701, such that switching is performed to the lite mode in step 702. Next, in the lite mode, a screen 72 of the lite mode is displayed in step 703. The user then presses the up arrow key 171 and the down arrow key 172 in step 709 so as to change a file in the list in step 705, such as to the second file of the video type having a screen 73. Alternatively, the left arrow key 173 and the right arrow key 174 are pressed in step 706 so as to change to a file list of a different type in step 707, such as a file list of the photo type having a screen 74. By continually pressing the right arrow key 179, the file list can be changed from the video type to the photo type, then to the music type, and again back to the video type in order. By pressing the left arrow key 173, the file list can be changed from the video type to the music type, then to the photo type, and again back to the video type.

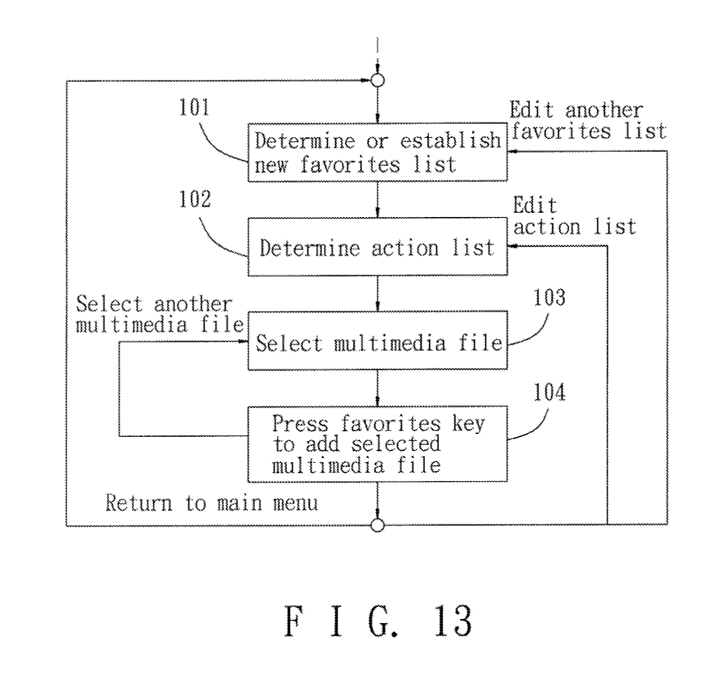

FIG. 12 illustrates a processing procedure of the lite mode of the digital media player 100. First, the digital media player 100 decides a favorites list 461 in step 401. In step 402, the digital media player 100 changes the favorites list 461 after receiving an instruction for changing the favorites list 461. The digital media player 100 loads the favorites list from “my favorites” in step 403, decides on a selected item in step 404, and plays or displays the selected item in step 405. Next, the digital media player 100 waits for a directional instruction from the up arrow key 171, down arrow key 172, left arrow key 173, or right arrow key 174 in step 406. In step 407, after receiving the directional instruction, the digital media player 100 determines what the directional instruction is. In step 408, if the directional instruction that is received is from the up arrow key 171 or the down arrow key 172, then a file in a list may be changed. In step 409, if the directional instruction that is received is from the left arrow key 173 or the right arrow key 174, then a file list may be changed to another type.

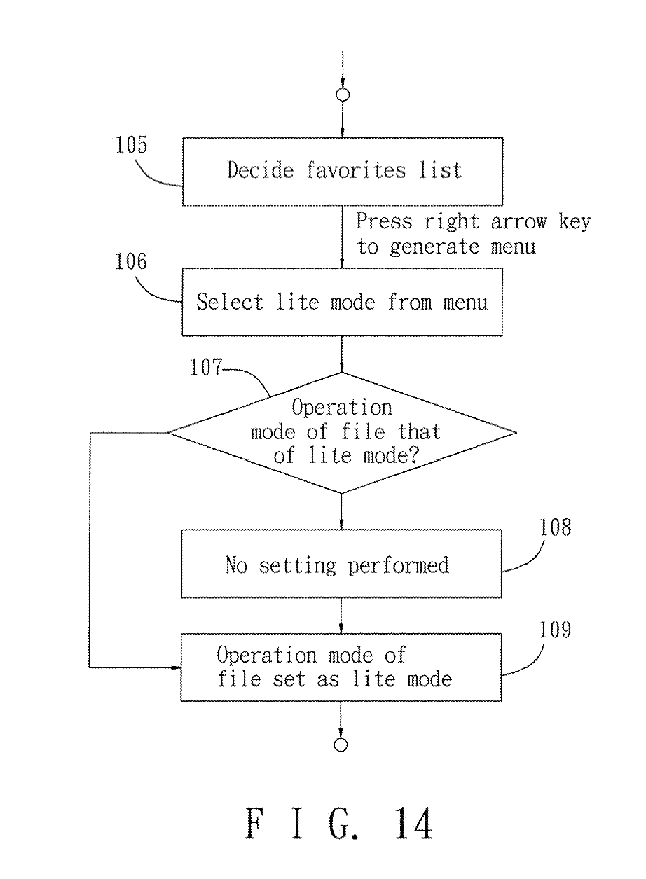

Referring to FIG. 13, a method of adding a my favorites folder includes steps as described in the following. A new favorites list is determined or established in step 101. Next, an action list is determined in step 102, and a multimedia file is selected in step 103. Subsequently, the favorites key 163 (see FIG. 2) is pressed to add the selected multimedia file in step 104. Next, another multimedia file may be selected, after which the flow returns to the main menu, and the action list may be edited, or another, favorites list may be edited.

The determination steps for adding the my favorites folder by the digital media player 100 is as follows: determine whether to establish a new my favorites list folder, wait to input a name for the my favorites list folder, provide types of multimedia files for selection, and determine whether establishing of the new my favorites list folder has been successfully completed.

Referring to FIG. 14, a method of adding a file to my favorites includes steps as outlined in the following. A favorites list is decided in step 105. Next, the right arrow key 174 is pressed to generate a menu, and the lite mode is selected from the menu in step 106. Next, it is determined whether an operation mode of a file is that of the lite mode in step 107. If not, setting is not performed in step 108. If the operation mode of the file is that of the lite mode, on the other hand, the operation mode of the file is set as the lite mode in step 109.

In summary, the display element 31 of the digital media player 100 is able to simultaneously present the video list 510 of the favorites list 461 for users to choose a multimedia file and directly display and play a chosen multimedia file. Therefore, even though people who do not know how to use a computer can operate the present invention easily, thereby achieving the purpose of the present invention.

While the present invention has been described in connection with what is considered the most practical embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A media file access control method for a digital media player, comprising:
a) receiving a mode selection instruction;
b) determining whether the mode selection instruction corresponds to a lite mode or a computer file mode; and
c) if the mode selection instruction corresponds to the lite mode, performing steps of loading a plurality of multimedia files according to content of a pre-established favorites list recording respective names and storage locations of the multimedia files, and displaying thumbnails of the multimedia files in a first region of a screen of a display element, the thumbnails of the multimedia files being capable of being selected such that the multimedia files can be played directly and instantly.

2. The media file access control method as claimed in claim 1, wherein in step c), when the thumbnail of one of the multimedia files corresponding to a video file or a photo file is selected, content of the selected multimedia file is displayed in a second region of the screen.

3. The media file access control method as claimed in claim 1, wherein in step c), when the thumbnail of one of the multimedia files corresponding to a music file is selected, tag information of the music file is displayed in the second region of the screen.

4. The media file access control method as claimed in claim 1, wherein the thumbnails of the multimedia files can be selected using an instructional scrolling mechanism, the instructional scrolling mechanism operating such that a media file in the same file group is selected when a first directional instruction from a first axial direction key set is received, and a different file group is selected when a second directional instruction from a second axial direction key set is received.

5. A digital media player for cooperating with a data source to acquire a plurality of multimedia files for presentation on a display element, comprising:
a remote control receiver for receiving a mode selection instruction;
a storage unit for storing a pre-established favorites list, content of the favorites list recording respective names and storage locations of the multimedia files; and
a program control module that acquires the mode selection instruction and determines whether the mode selection instruction corresponds to a lite mode or a computer file mode, and if the mode selection instruction corresponds to the lite mode, loads the multimedia files according to content of the pre-established favorites list recording respective names and storage locations from said storage unit, and that displays thumbnails of the multimedia files in a first region of a screen of the display element, the thumbnails of the multimedia files being capable of being selected such that the multimedia files can be played directly and instantly.

6. The digital media player as claimed in claim 5, wherein when said program control module determines that the thumbnail of one of the multimedia files corresponding to a video file or a photo file is selected, content of the selected multimedia file is displayed in a second region of the screen of the display element.

7. The digital media player as claimed in claim 5, wherein when said program control module determines that the thumbnail of one of the multimedia files corresponding to a music file is selected, tag information of the music file is displayed in the second region of the screen of the display element.

8. The digital media player as claimed in claim 5, wherein said program control module utilizes an instructional scrolling mechanism to effect controlling and choosing the thumbnails of the multimedia files, the instructional scrolling mechanism operating such that a media file in the same file group is selected when a first directional instruction from a first axial direction key set is received, and a different file group is selected when a second directional instruction from a second axial direction key set is received.

9. A method of adding a my favorites folder for a digital media player, comprising:
a) determining whether to establish a new my favorites list folder;
b) waiting for input of a name for the my favorites list folder;
c) providing types of multimedia files for selection; and
d) determining whether establishing of the new my favorites list folder has been successfully completed.

10. A digital media player cooperating with a data source so as to obtain one or more multimedia files for play on a display element, comprising:
a remote control receiver for receiving a directional instruction;
a storage unit for storing a favorites list, the favorites list including file paths of the multimedia files; and
a program control module that executes a process of a lite mode and includes
a directory processing unit that loads the multimedia files according to file paths in the favorites list, that generates a thumbnail list for previewing thumbnails of the multimedia files, and that selects a different multimedia file from the thumbnail list according to the received directional instruction, a play processing unit for playing the multimedia file selected by the directional instruction and generating an image, and
a display control unit that arranges the thumbnail list in a first region of a screen and the image in a second region of the screen, and integrates the thumbnail list and the image into a display signal; and
a video interface which converts the display signal into an output signal that is suitable for display on the display element, and which outputs the output signal to the display element.

11. The digital media player as claimed in claim 10, wherein said directory processing unit controls the thumbnails in the thumbnail list to scroll for preview according to the directional instruction, the thumbnail list including a predetermined window, the thumbnail within the predetermined window for preview representing a selected multimedia file.

12. The digital media player as claimed in claim 10, wherein a media file in the same file group is selected when said directory processing unit receives a first directional instruction from a first axial direction key set, and a different file group is selected when said directory processing unit receives a second directional instruction from a second axial direction key set.

13. The digital media player as claimed in claim 10, further comprising a remote controller having a mode key, said program control module executing a process related to the lite mode after said mode key is pressed.
